(19) United States
(12) Patent Application Publication
(10) Pub. No.: US 2017/0216954 A1
(43) Pub. Date: Aug. 3, 2017

(54) APPARATUSES, SYSTEMS, AND METHODS FOR REDUCING OR ELIMINATING GAS SURGES IN WELDING APPLICATIONS

(71) Applicants: Scott Blankman, Omaha, NE (US); Christopher P. Rauch, Barrington, IL (US)

(72) Inventors: Scott Blankman, Omaha, NE (US); Christopher P. Rauch, Barrington, IL (US)

(21) Appl. No.: 15/423,531

(22) Filed: Feb. 2, 2017

Related U.S. Application Data
(60) Provisional application No. 62/290,850, filed on Feb. 3, 2016.

(51) Int. Cl. B23K 9/16; B23K 35/38

(52) U.S. Cl. CPC B23K 9/164; B23K 35/38

(57) ABSTRACT

Apparatuses, systems, and/or methods for reducing or eliminating gas surges in welding applications are disclosed. The welding system can include, for example, a welding cable coupled to a welding torch in which the welding torch, for example, includes a gas surge protector. The gas surge protector is in flow communication with a gas tube that runs at least partially through the welding cable and provides shielding gas for welding applications. The gas surge protector eliminates gas surges and stabilizes gas flow.

### CROSS-REFERENCE TO RELATED APPLICATIONS

The present application claims priority to and benefit from U.S. Application No. 62/290,850, filed Feb. 3, 2016. The above-identified application is hereby incorporated herein by reference in its entirety.

### BACKGROUND

Shielding gas surges are a common and costly problem in welding applications and can be caused by, for example, the built up back pressure of welding system components.

What is needed is an apparatus, a system, or a method that reduces or eliminates gas surges and stabilizes gas flow in a welding application.

### BRIEF SUMMARY

Apparatuses, systems, and methods for reducing or eliminating gas surges in welding applications are provided substantially as illustrated by and/or described in connection with at least one of the figures, as set forth more completely in the claims.

### BRIEF DESCRIPTION OF THE DRAWINGS

FIG. 1 shows an embodiment of a system for reducing or eliminating gas surges in welding applications according to the present disclosure.

FIG. 2 shows an embodiment of a gas surge protector according to the present disclosure.

FIG. 3 shows a cross-sectional view of the gas surge protector shown in FIG. 2 according to an embodiment of the present disclosure.

FIG. 4 shows an embodiment of an adaptor for the gas surge protector according to the present disclosure.

### DETAILED DESCRIPTION

Some embodiments of apparatuses, systems, and methods for reducing or eliminating gas surges in welding applications are provided.

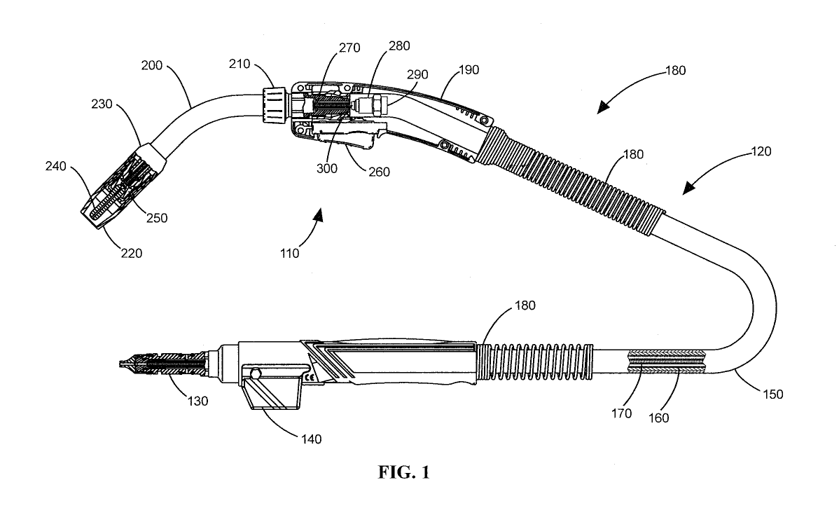

FIG. 1 shows an embodiment of a system 110 for reducing or eliminating gas surges in welding applications according to the present disclosure. Referring to FIG. 1, the system 100 includes, for example, a welding torch 110 connected to a welding cable 120. In some embodiments, the welding torch 110 is a welding gun or a cutting torch (e.g., a plasma cutter).

In some embodiments, the welding cable 120 is connected to a welding power supply and a shielding gas source which are not shown. The welding cable 120 includes, for example, a power pin 130 and a trigger wire connector cover 140 for connecting to the welding power supply, for example. The welding cable 120 houses, for example, a power cable 150 and a gas tube 160 with a liner 170. The power cable 150 is connected to the welding power supply. The gas tube 160 is connected to the shielding gas source. The gas tube 160 can also be connected to the shielding gas source via the welding power supply. One or more springs 180 can be wrapped around the end portions of welding cable 120 to relieve strain in the welding cable 120.

In some embodiments, the welding torch 110 is connected to an end of the welding cable 120 and houses the gas tube 160 and the power cable 150 from the welding cable 120. The welding torch 110 provides a handle 190 that is connected to the welding cable 120. The handle 190 is connected to a neck 200 of the welding torch 110 via a nut 210. The neck 200 extends to form a nozzle 220 at an end portion of the welding torch 110. The nozzle 220 provides an insulator 230 (e.g., electrical insulator and/or heat insulator) that forms part of the housing of the nozzle 220. The nozzle 220 houses a contact tip 240 and a gas diffuser 250. The contact tip 240 is electrically connected to the power cable 150. The gas diffuser 250 is in flow communication with the gas tube 160.

In some embodiments, the handle 190 includes a trigger 260 that is configured to cause a welding arc at the contact tip 240. The handle 190 also includes a heat sink 270 that surrounds the power cable 150.

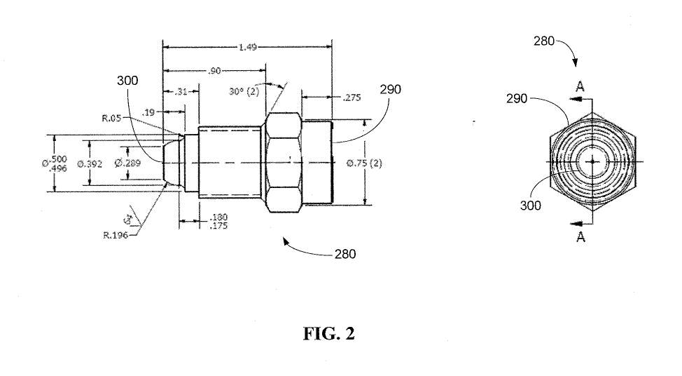

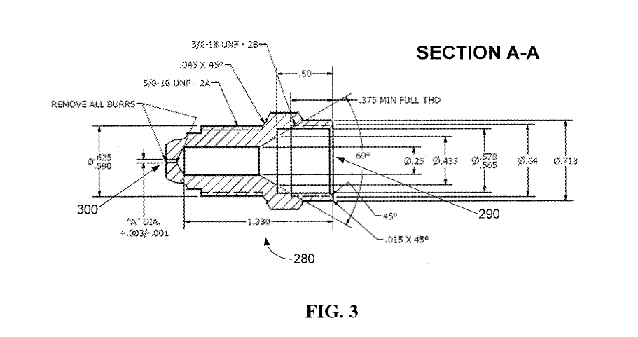

In some embodiments, the handle 190 or the welding torch 110 includes a gas surge protector 280. FIGS. 2 and 3 show different views of an embodiment of the gas surge protector 280. On one end portion, the gas surge protector 280 has an opening 290 that is connected to the gas tube 160. The gas surge protector 280 is configured to allow shielding gas from the gas tube 160 to pass through the gas surge proctor 280. The gas surge protector 280 narrows to an orifice 300 in the normal gas flow direction. The gas surge protector 280 is structurally configured and physically disposed within the handle 190 or the welding torch 110 to reduce or eliminate gas surges and to stabilize gas flow.

In some embodiments, the gas surge protector 280 includes a switch that allows the orifice 300 to change diameter like an iris or a diaphragm, or to replace the orifice 300 with another orifice 300 with a different diameter. In some embodiments, the orifice diameter can be adjusted to provide an adjustable gas surge protector 280 that can provide a fixed or adjustable flow rate. In some embodiments, the orifice diameter can be physically changed. In some embodiments, the orifice 300 can be one of a plurality of orifices 300 with different diameters that can be switched in or out using mechanical or electromechanical means such as, for example, a dial with multiple orifices along the circumference of the dial that can be switched into place. In some embodiments, a plurality of orifices axially aligned from largest diameter to smallest can be used to reduce the effective orifice of the gas surge protector 280 as smaller diameters are inserted into the gas flow. In some embodiments, the gas surge protector 280 includes an electronic surge protector that regulates and monitors flow rates and eliminates gas surges.

In some embodiments, the gas surge protector 280 is disposed within the handle 190 or the welding torch 110 so that a welding operator cannot easily access or remove the gas surge protector 280. Making the gas surge protector 280 less accessible protects the gas surge protector 280 from tampering, for example, by a welding operator. In some embodiments, the gas surge protector 280 is screwed into place, or removably inserted, locked, or interfaced. In other embodiments, the gas surge protector 280 is more permanently mounted. In some embodiments, the gas surge protector 280 is formed as an integral part of the handle 190 or the welding torch 110, for example, and cannot easily be separated from the handle 190 or the welding torch 110.

In some embodiments, the gas surge protector 280 is located at a position anywhere from a tip of the welding torch 110 to the end of the power pin 130 (or the welding cable 120). In some embodiments, the gas surge protector 280 is located at a position downstream of or including an end of the power pin 130 or the welding cable 120 or the handle 190. In some embodiments, the gas surge protector 280 is located at a position downstream of the handle 190 or the heat sink 270 or the nut 210 or the neck 200 or the insulator 230 or the gas diffuser 250. In some embodiments, the gas surge protector 280 is located in, around, or as part of one or more of the following: the nozzle 220 of the welding torch 110, the gas diffuser 250 of the welding torch 110, the neck 200 of the welding torch 110, the nut 210 of the welding torch 110, the handle 190 of the welding torch, the welding cable 120, and the power pin 130. In some embodiments, the gas surge protector 280 can be placed in multiple places downstream of or including an end of the power pin 130 (or the welding cable 120). In some embodiments, multiple gas surge protectors 280 can be placed in one or more places downstream of or including an end of the power pin 130 or the welding cable 120 or handle 190. In other embodiments, the gas surge protector 280 can be removably screwed, inserted, locked, or interfaced, or more permanently mounted. In some embodiments, the gas surge protector 280 is formed as an integral part of the welding torch 110, the gas diffuser 250, the neck 200, the nut 210, the handle 190, the welding cable 120, and the power pin 130, for example, and cannot easily be separated from the welding torch 110, the gas diffuser 250, the neck 200, the nut 210, the handle 190, the welding cable 120, and the power pin 130.

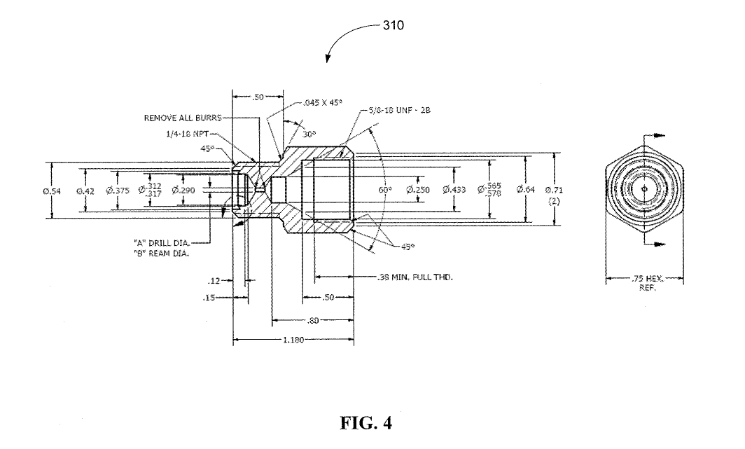

In some embodiments, the gas surge protector 280 is used with an adaptor 310, an embodiment of which is illustrated in FIG. 4. The gas surge protector 280 can screw into the adaptor 310, or vice versa, so that the end portions of combination of the gas surge protector 280 and the adaptor 310 correctly fit with the gas tube 160 on either side of the combination. The gas surge protector 280 and the adaptor can be permanently made integral, or can be formed to be integral with the handle 190 or the welding torch 110.

In operation, the gas surge protector 280 reduces and stabilizes the shielding gas flow. In conventional systems, when the trigger 260 is triggered causing an arc at the contact tip 240, a four to eight second gas surge can occur due to build up back pressure in the system all the way to the feeder between the shielding gas source and the power supply. In some embodiments, the insertion of the gas surge protector 280 inside the handle 190 or the welding torch 110 reduces or eliminates any gas surges that might occur during a welding operation, for example. Further, the placement of the gas surge protector 280 in the handle 190 or the welding torch 110 reduces the amount of built up back pressure to just the part of the gas tube from the gas surge protector 280 to the nozzle 220. This reduces any flow instabilities and the possibility of contaminants in the weld. Some embodiments contemplate placing the gas surge protector 280 at the diffuser 250 or as close to the point of gas shielding as possible, which would even further reduce the amount of built up back pressure.

The reduced diameter at the orifice 300 of the gas surge protector insures that excess shielding gas is not a problem. Not only is excess shielding gas costly, but excess shielding gas can cause weld quality issues such as, for example, turbulent flow, turbulent weld puddle, Venturi effects, aspiration, and atmosphere contamination.

Some embodiments that employ the gas surge protector 280 in the handle 190 or the welding torch 110 can be used in different types of applications including, for example, metal inert gas (MIG) welding applications, tungsten inert gas (TIG) welding, gas metal arc welding (GMAW), gas tungsten arc welding (GTAW), arc welding, stick welding, resistance welding, solid state welding, micro welding, plasma cutting, etc.

Some embodiments that employ the gas surge protector 280 in the handle 190 or the welding torch 110 provide shielding gas reduction of at least forty percent for the welding operator with improved welding quality.

Some embodiments that employ the gas surge protector 280 in the handle 190 or the welding torch 110 eliminate the need for flow meters and further reduce maintenance costs.

Some embodiments that employ the gas surge protector 280 in the handle 190 or the welding torch 110 eliminate turbulence in the weld puddle and reduce weld porosity.

Some embodiments that employ the gas surge protector 280 in the handle 190 or the welding torch 110 eliminate turbulent gas flow and reduce weld porosity.

Some embodiments that employ the gas surge protector 280 in the handle 190 or the welding torch 110 provide different fixed flow rates (e.g., 35 scfh, 45 scfh, 55 scfh, etc.).

Some embodiments that employ the gas surge protector 280 in the handle 190 or the welding torch 110 provide different fixed flow rates (e.g., 35 scfh, 45 scfh, 55 scfh, etc.).

Some embodiments that employ the gas surge protector 280 in the handle 190 or the welding torch 110 provide continuous or discrete adjustable flow rates.

Some embodiments that employ the gas surge protector 280 provide for the stabilization of transient gas flow events as the gas works towards a stead state gas flow.

While the present apparatuses, systems, and/or methods have been described with reference to certain implementations, it will be understood by those skilled in the art that various changes may be made and equivalents may be substituted without departing from the scope of the present apparatuses, systems, and/or methods. In addition, many modifications may be made to adapt a particular situation or material to the teachings of the present disclosure without departing from its scope. Therefore, it is intended that the present apparatuses, systems, and/or methods not be limited to the particular implementations disclosed, but that the present apparatuses, systems, and/or methods will include all implementations falling within the scope of the appended claims.

What is claimed is:

1. A welding system, comprising:
a welding torch that is configured to receive a gas surge protector that is in flow communication with a gas tube.

2. The welding system according to claim 1, comprising:
a welding cable coupled to the welding torch, wherein the gas tube runs at least partially through the welding cable.

3. The welding system according to claim 1, wherein the welding torch includes a handle, and wherein the gas surge protector is housed in the handle of the welding torch.

4. The welding system according to claim 1, wherein the gas surge protector has a first end with a first diameter and a second end with a second diameter, wherein the first diameter is smaller than the second diameter, and wherein gas flows from the gas tube through the second end and then through the first end.

5. The welding system according to claim 1, wherein the welding torch includes a nozzle that is configured to house the gas surge protector.

6. The welding system according to claim 1, wherein the gas surge protector is located downstream of a welding cable.

7. The welding system according to claim 1, comprising an adaptor that is coupled to the gas surge protector so that an end of the adaptor provides flow communication to the gas surge protector and provides a diameter that is different from the diameter of an end portion of the gas surge protector.

8. The welding system according to claim 1, wherein the gas surge protector is configured to eliminate or reduce shielding gas surges during welding operations.

9. The welding system according to claim 1, wherein the gas surge protector has a first end with a first diameter and a second end with a second diameter, wherein the first diameter is smaller than the second diameter, and wherein the first diameter is adjustable.

10. A welding system, comprising:
a welding torch coupled to a power pin via a welding cable,
wherein the welding system is configured to receive a gas surge protector that is in flow communication with a gas tube, and
wherein the gas surge protector is located in the welding system at a position anywhere from a tip of the welding torch to an end of the power pin.

11. The welding system according to claim 10, wherein the gas surge protector is located in one of more of the following: a nozzle of the welding torch, a gas diffuser of the welding torch, an insulator of the nozzle, a neck of the welding torch, a nut of the welding torch, a handle of the welding torch, a welding cable, and the power pin.

12. The welding system according to claim 10, wherein the gas surge protector is located downstream of the welding cable.

13. A welding torch, comprising:
a nozzle coupled to a first end portion of a neck; and
a handle coupled to a second end portion of the neck,
wherein the handle is configured to house a gas surge protector through which shielding gas passes from the handle to the neck.

14. The welding torch according to claim 13, wherein the gas surge protector has a first end with a first diameter and a second end with a second diameter, wherein the first diameter is smaller than the second diameter, and wherein the shielding gas flows from the second end to the first end of the gas surge protector.

15. The welding torch according to claim 13, wherein the gas surge protector is located downstream of a welding cable and a welding power supply.

16. The welding torch according to claim 13, comprising an adaptor that is coupled to the gas surge protector so that an end of the adaptor is used to provide flow communication with the gas surge protector.

17. The welding torch according to claim 13, wherein the gas surge protector is configured to eliminate shielding gas surges during welding operations.

18. The welding torch according to claim 13, wherein the gas surge protector is configured to stabilize gas flow.

19. The welding torch according to claim 13, wherein the gas surge protector is configured to reduce turbulent weld puddles during a welding operation.

20. The welding torch according to claim 13, wherein the gas surge protector has a first end with a first diameter and a second end with a second diameter, wherein the first diameter is smaller than the second diameter, and wherein the first diameter is adjustable.

21. A method of eliminating or reducing gas surges in a welding application, comprising:
providing shielding gas through a welding torch via a welding cable; and
providing a gas surge protector in the welding cable or downstream of the welding cable.

22. The method according to claim 21, comprising:
eliminating or reducing, by the gas surge protector, gas surges during a welding operation.

23. The method according to claim 21, wherein the gas surge protector is provided in one of more of the following: a nozzle of the welding torch, a gas diffuser of the welding torch, a neck of the welding torch, a nut of the welding torch, an insulator of the nozzle, a handle of the welding torch, and the welding cable.
